(19) United States
(12) Patent Application Publication
(10) Pub. No.: US 2026/0340360 A1
(43) Pub. Date: Oct. 29, 2026

(54) MANAGING GENERATIVE ARTIFICIAL INTELLIGENCE (AI) MODEL OUTPUTS USING BINARIZED REPRESENTATIONS

(71) Applicant: Dell Products L.P., Round Rock, TX (US)

(72) Inventors: OFIR EZRIELEV, Be'er Sheva (IL); HANNA YEHUDA, Acton, MA (US); ANNE-MARIE MCREYNOLDS, San Jose, CA (US)

(21) Appl. No.: 19/191,508

(22) Filed: Apr. 28, 2025

(51) Int. Cl. G06N 3/0475; G06F 16/3329; G06N 3/10

(52) U.S. Cl. CPC G06N 3/0475; G06F 16/33295; G06N 3/105

(57) ABSTRACT

Methods and systems for providing computer-implemented services using generative artificial intelligence (AI) models are disclosed. To do so, an output generated by a generative AI model based on an input may be obtained. A causality analysis process may be obtained using at least the input, the output, and the generative AI model to obtain a set of causal relationships between first information elements of the input and second information elements of the output. The set of the causal relationships may be based on first binarized representations of perturbated inputs based on the input and second binarized representations of perturbated outputs based on the perturbated inputs. Computer-implemented services may be provided to a downstream consumer using at least the set of the causal relationships.

### FIELD

Embodiments disclosed herein relate generally to providing computer-implemented services using generative artificial intelligence (AI) models. More particularly, embodiments disclosed herein relate to managing generative AI model outputs using binarized representations.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a diagram illustrating a system in accordance with an embodiment.

FIGS. 2A-2C show flow diagrams illustrating data flows in accordance with an embodiment.

FIGS. 2D-2F show examples of data used to perform causality analysis processes in accordance with an embodiment.

FIGS. 3A-3B show flow diagrams illustrating a method for providing computer-implemented services using generative AI models in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for providing computer-implemented services using generative AI models. The generative AI models may include large language models (LLMs) that may generate outputs when provided with input. The outputs may be used, at least in part, to provide the computer-implemented services. For example, the outputs may be provided to a downstream consumer and the downstream consumer may use the outputs to make decisions.

However, a usefulness of the outputs to the downstream consumer may be reduced if the downstream consumer does not understand why an output was generated. For example, a downstream consumer (e.g., a client, a customer) may desire to use an output to manage a computer system. However, if the LLM does not operate as expected (e.g., due to data drift in training data and/or production data, due to bias in the training data and/or production data), the output may negatively impact the computer system. In addition, the computer system managed by the client may store private medical information, private financial information, and/or other data protected by various regulatory standards (e.g., General Data Protection Regulation (GDPR), Health Insurance Portability and Accountability Act (HIPAA)). The client may choose not to utilize the output generated by the LLM if the client is unable to determine whether the output generation process complies with one or more regulatory standards.

To increase a likelihood of outputs generated by generative AI models meeting expectations of downstream consumers, explainability information for outputs may be provided along with the outputs to downstream consumers. Explainability information may provide downstream consumers with insight into a generative AI model's decision-making processes and may allow the downstream consumer to make adjustments to the prompt to alter a particular portion of the output.

The explainability information may include relationships between portions of the input and portions of the output (e.g., causal relationships and/or correlative relationships). For example, the relationships may include a set of causal relationships that predict causality between the portions of the input and the portions of the output.

To generate a set of causal relationships, a generative AI model may generate an output when provided with an input (e.g., a prompt, a pre-prompt, retrieval-augmented generation (RAG) supplemental information, prompt templating data). The input, the output, and the generative AI model may be used to perform a causality analysis process to obtain the set of the causal relationships.

Performing the causal analysis process may include: (i) iteratively perturbating the input to obtain perturbated inputs, (ii) obtaining, using the perturbated inputs and the generative AI model, perturbated outputs, (iii) obtaining, using the perturbated inputs, the perturbated outputs, and a binarization schema, first binarized representations of the perturbated inputs and second binarized representations of the perturbated outputs, (iv) performing, using the first binarized representations, the second binarized representations and a causal inferencing algorithm, a causal inferencing process to obtain the set of the causal relationships, and/or (v) other methods.

The binarization schema may include instructions for generating binarized representations of information content of the perturbated inputs and the perturbated outputs. For example, a binarized representation may include binary data (e.g., 0 or 1, yes or no, A or B) that indicates a presence or an absence of a particular information element in the corresponding perturbated input or perturbated output.

As an example, a first binarized representation (e.g., corresponding to a first perturbated input of the perturbated inputs) may include: (i) an aggregated list of input information elements extracted from all of the perturbated inputs, and (ii) binary designations indicating either a presence or an absence of each information element of the aggregated list of the input information elements in the first perturbated input. Therefore, the first binarized representation may include a “0 ” for each absent information element and a “1” for each present information element (e.g., if the binary designations are represented as “0 ” or “1”). Binary representations and binary designations may be represented via other methods without departing from embodiments disclosed herein (e.g., “yes” for presence and “no” for absence).

Thus, embodiments disclosed herein may provide an improved method for providing computer-implemented services using generative AI models. To provide the computer-implemented services as desired by downstream consumers, the set of causal relationships may be used to generate explainability information usable to interpret outputs from the generative AI model. By doing so, a likelihood that the computer-implemented services may meet expectations of the downstream consumers may be increased.

In an embodiment, a method for providing computer-implemented services using generative AI models is provided. The method may include: obtaining an output generated by a generative AI model of the generative AI models based on an input; performing, using at least the input, the output, and the generative AI model, a causality analysis process to obtain a set of causal relationships between first information elements of the input and second information elements of the output, the set of the causal relationships being based, at least in part, on: first binarized representations of perturbated inputs based on the input, and second binarized representations of perturbated outputs based on the perturbated inputs; and providing computer-implemented services to a downstream consumer using at least the set of the causal relationships.

The input may include at least one type of data selected from a list of types of data consisting of: a prompt for the generative AI model, and a pre-prompt for the generative AI model.

Performing the causality analysis process may include: iteratively perturbating the input to obtain the perturbated inputs; obtaining, using the perturbated inputs and the generative AI model, the perturbated outputs; obtaining, using the perturbated inputs, the perturbated outputs, and a binarization schema, the first binarized representations and the second binarized representations; and performing, using the first binarized representations, the second binarized representations and a causal inferencing algorithm, a causal inferencing process to obtain the set of the causal relationships.

Iteratively perturbating the input may include: obtaining the first information elements of the input; and performing at least one action selected from a list of actions consisting of: removing a first information element of the first information elements to obtain a first perturbated input of the perturbated inputs; and replacing the first information element with a replacement information element to obtain the first perturbated input.

The method of may also include: prior to obtaining the first binarized representations and the second binarized representations: generating first graphical representations of the perturbated inputs; and generating second graphical representations of the perturbated outputs.

A first graphical representation of the first graphical representations may include: nodes corresponding to information elements of a first perturbated input of the perturbated inputs; and edges indicating relationships between the nodes.

Obtaining the first binarized representations and the second binarized representations may include: based on the binarization schema: aggregating, using the perturbated inputs, information elements of the perturbated inputs to obtain aggregated input information elements; aggregating, using the perturbated outputs, information elements of the perturbated outputs to obtain aggregated output information elements; and for a first perturbated input of the perturbated inputs: comparing information elements of the first perturbated input to the aggregated input information elements to obtain a first binarized representation of the first binarized representations, the first binarized representation comprising a set of binary designations corresponding to the aggregated input information elements.

The set of the binary designations may include a first binary designation that indicates: a presence of a first information element of the aggregated input information elements in the first perturbated input, or an absence of the first information element of the aggregated input information elements in the first perturbated input.

The causal inferencing algorithm may include at least one causal inferencing algorithm selected from a list of causal inferencing algorithms consisting of: regression analysis, causal mediation analysis, propensity score matching, and uplift modeling.

Providing the computer-implemented services to the downstream consumer may include: populating a graphical user interface (GUI) with at least the set of the causal relationships to obtain a populated GUI, the populated GUI being accessible by the downstream consumer.

The generative AI model may be a large language model (LLM).

In an embodiment, a non-transitory media is provided. The non-transitory media may include instructions that when executed by a processor cause the computer-implemented method to be performed.

In an embodiment, a system is provided. The system may include the non-transitory media and a processor, and may perform the computer-implemented method when the computer instructions are executed by the processor.

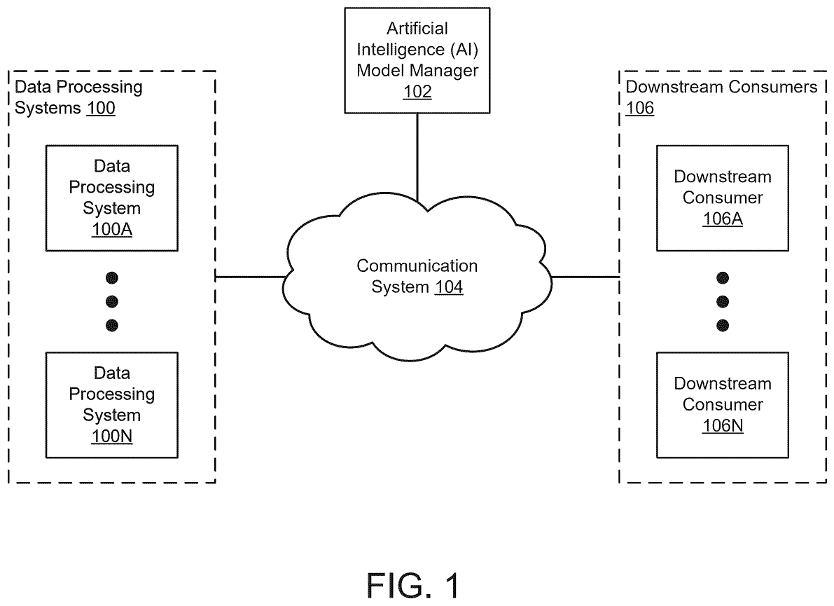

Turning to FIG. 1, a block diagram illustrating a system in accordance with an embodiment is shown. The system shown in FIG. 1 may provide for management of data processing systems that may provide, at least in part, computer-implemented services (e.g., to users of the system and/or devices operably connected to the system).

The computer-implemented services may include any type and quantity of computer-implemented services. The computer-implemented services may include, for example, database services, data processing services, electronic communication services, inference generation services, and/or any other services that may be provided using one or more computing devices. The computer-implemented services may be provided by, for example, data processing systems 100, AI model manager 102, downstream consumers 106, and/or any other type of devices (not shown in FIG. 1). Other types of computer-implemented services may be provided by the system shown in FIG. 1 without departing from embodiments disclosed herein.

The computer-implemented services may be provided, at least in part, using generative AI models and/or outputs obtained using the generative AI models. To do so, data processing systems 100 and/or AI model manager 102 may host any number of generative AI models.

To obtain the outputs, the generative AI models may be trained, using training data, to generate the outputs when provided with inputs (e.g., ingest data, prompts, pre-prompts, templated prompts, supplementary data). The generative AI models may include large language models (LLMs) and, therefore, the outputs may include new instances of data created by the generative AI models based on learned associations from and/or an understanding of the training data. For example, the generative AI models may be trained using unstructured data, such as stories, essays, audio transcription, video description, and/or other types of human interpretable text, to generate outputs of the same. The outputs may be provided to downstream consumers 106 (e.g., client devices, data processing systems that manage computer systems and/or production systems) as part of providing the computer-implemented services.

However, the outputs may be provided to downstream consumers 106 as part of: (i) customer service requests (e.g., troubleshooting computer systems), (ii) data management processes (e.g., healthcare data, financial data), (iii) production system management processes (e.g., industrial applications), and/or (iv) other processes. The outputs, therefore, may be desired (e.g., by downstream consumers 106) to meet certain expectations. For example, downstream consumers 106 may expect the generative AI model and the outputs to comply with data privacy regulations (e.g., GDPR, HIPAA), may desire to mitigate unintended bias in outputs (e.g., when using the responses to make decisions based on financial data of consumers), and/or may otherwise wish to understand, audit, and/or modify operation of the generative AI models. If downstream consumers 106 are unable to determine whether the generative AI models and/or the outputs meet their expectations, a usefulness of the outputs to downstream consumers 106 may be reduced.

In general, embodiments disclosed herein may provide methods, systems, and/or devices for providing explainability information to downstream consumers along with the outputs generated by the generative AI models. The explainability information may describe (e.g., in human-interpretable text, using graphical representations) why the generative AI model generated an output (e.g., may indicate correlative and/or causal relationships between portions of an input and portions of the output). For example, a set of causal relationships may be obtained to predict causation between information elements of the input and information elements of the output.

To do so, input for a generative AI model (e.g., a prompt, a pre-prompt, a prompt template, RAG supplemental data for the prompt) may be obtained and used to obtain an output from the generative AI model. To obtain the set of the causal relationships, a causality analysis process may be performed using at least the input, the output, and the generative AI model. The set of the causal relationships may be used to provide computer-implemented services to a downstream consumer.

To perform the causal analysis process, the prompt may be iteratively perturbated to obtain perturbated prompts. The perturbated prompts and the generative AI model may be used to obtain perturbated outputs. Graph data structures may be obtained for the perturbated inputs and the perturbated outputs (e.g., nodes corresponding to information elements of the perturbated inputs, nodes corresponding to information elements of the corresponding outputs, edges indicating relationships between nodes). First graphical representations of the perturbated inputs and second graphical representations of the perturbated outputs may be generated using the graph data structures. The first graphical representations and the second graphical representations may be used to populate a graphical user interface (GUI) and downstream consumers may have access to the GUI.

A binarization schema may be used to generate, using the perturbated inputs and the perturbated outputs (e.g., the graph data structures corresponding to the perturbated inputs and the perturbated outputs), first binarized representations of the perturbated inputs and second binarized representations of the perturbated outputs. For example, the first binarized representations may include a binarized representation for each perturbated prompt of the perturbated prompts and the second binarized representations may include a binarized representation for each perturbated output of the perturbated outputs.

A causal inferencing process may be performed, using the first binarized representations, the second binarized representations and a causal inferencing algorithm, to obtain the set of the causal relationships.

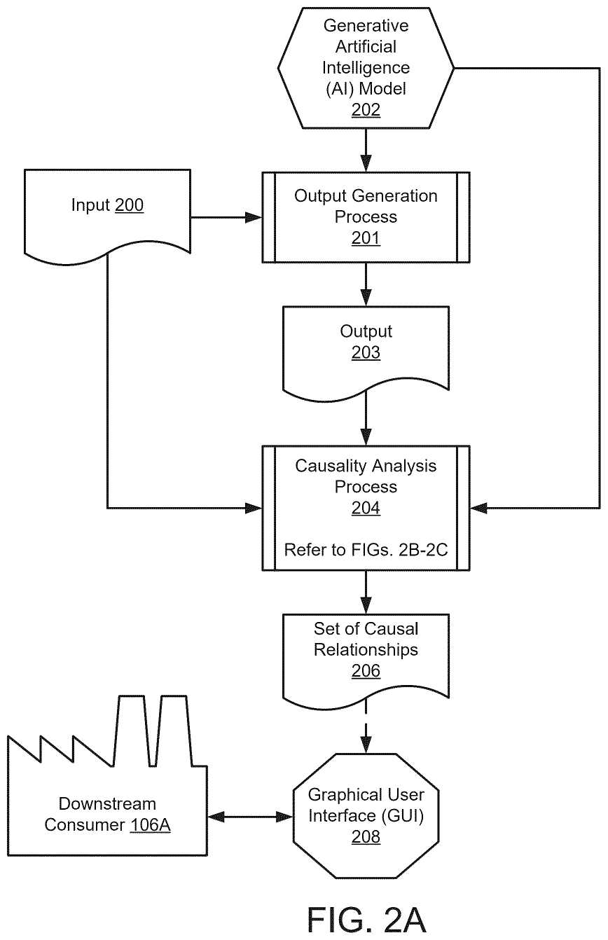

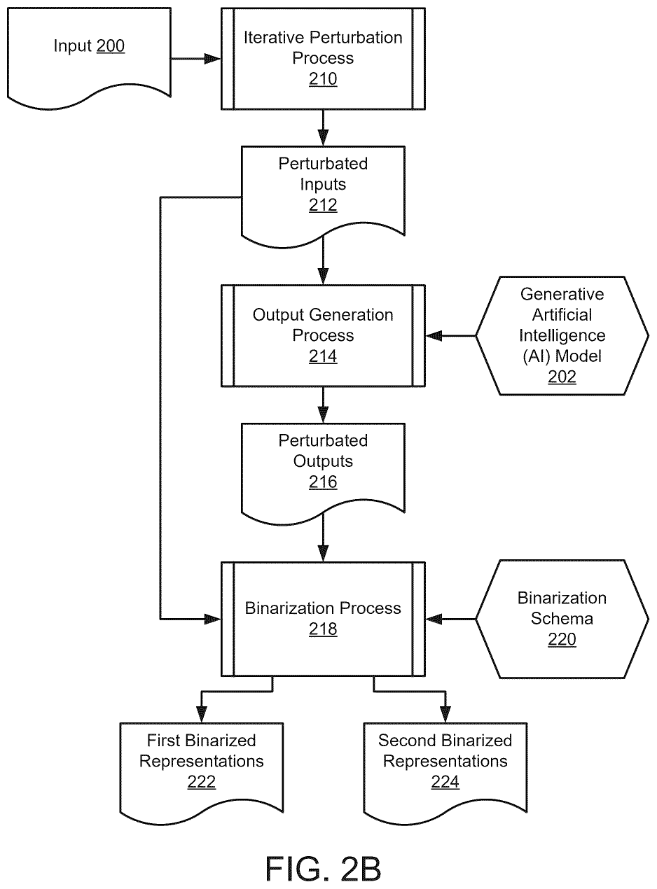

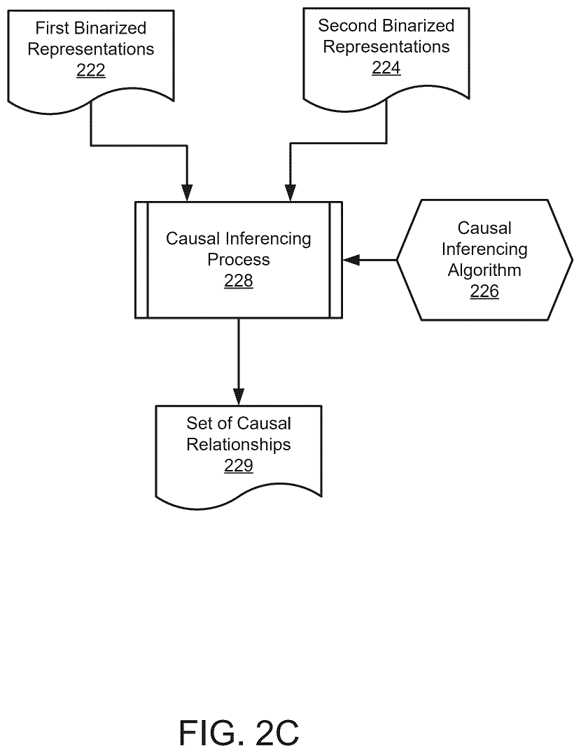

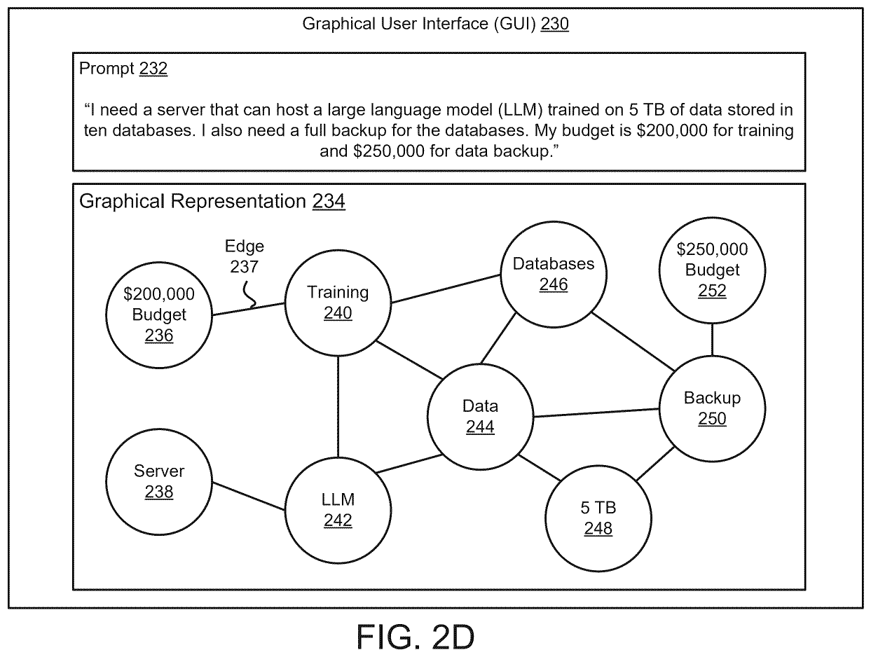

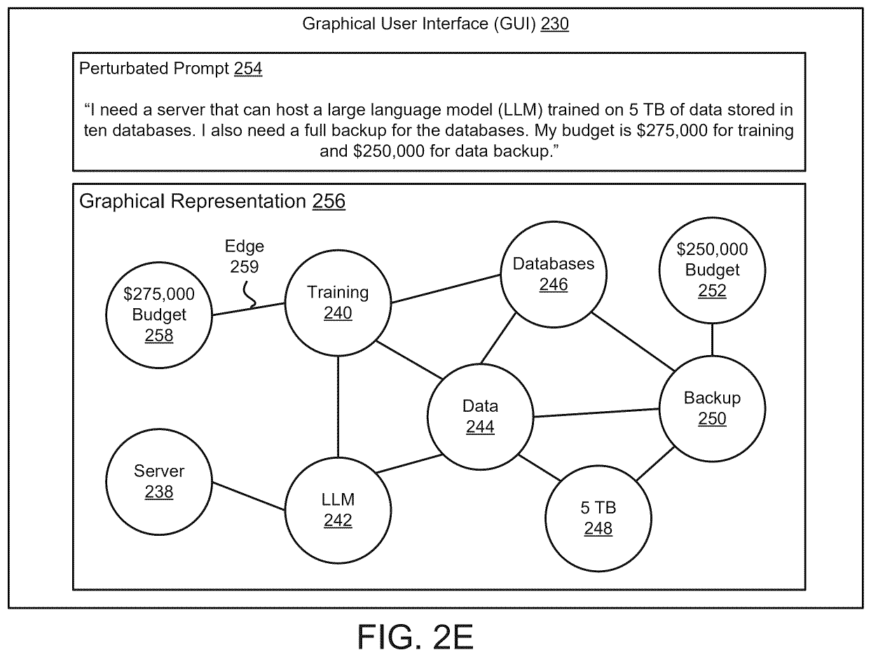

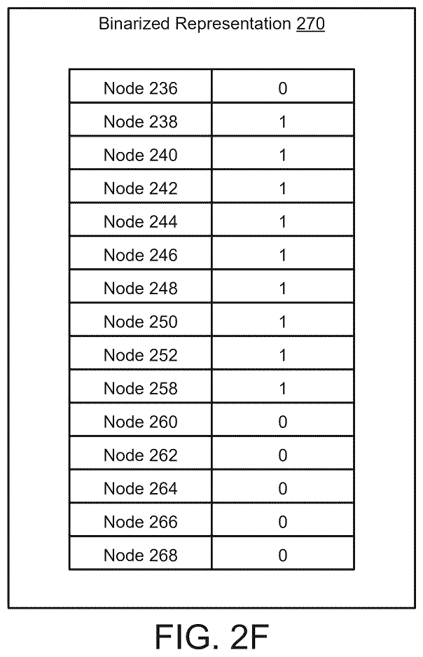

For example, a first binarized representation of the first binarized representations may include: (i) aggregated input information elements (e.g., a list of information elements aggregated across all of the perturbated inputs), and (ii) binary designations indicating either a presence or an absence of each of the aggregated input information elements in the first perturbated input. Each binarized representation, therefore, may include binary data (e.g., 0 or 1, yes or no, A or B). Refer to FIG. 2F for an example of a binarized representation of a perturbated input. By doing so, the perturbated inputs and the perturbated outputs may be represented using sets of binary data.

Information elements of the perturbated inputs and/or the perturbated outputs may include descriptors (e.g., ordinal features, numerical values) and, therefore, may be assigned a non-binary state selected from a finite set of states (e.g., low/medium/high, first/second/third, A/B/C/D). Therefore, the binarization schema (e.g., and/or another schema) may also include instructions for assigning designations to information elements (e.g., as part of a binarized representation of a perturbated input and/or a perturbated output) that are selected from a finite list of states. The finite list of states may include a binary set of states (e.g., 0 or 1) or may include a non-binary set of states (e.g., low or medium or high).

For example, if an information element of the aggregated input information elements includes a budget provided by a downstream consumer, one of four possible designations may be assigned to each perturbated input for the budget information element. The four possible designations may include: (i) “absent” to indicate that no budget information element exists in the perturbated input, (ii) “present, 1” to indicate that a budget information element exists in the perturbated input and the magnitude of the budget is assigned a state of 1 out of 3, with 1being the lowest budget and 3 being the highest budget, (iii) “present, 2” to indicate that the budget information element exists in the perturbated input and the magnitude of the budget is assigned a state of 2 out of 3 to indicate that the magnitude of the budget information element has a medium magnitude relative to the other perturbated inputs, and (iv) “present, 3” to indicate that the budget information element exists in the perturbated input and that the magnitude of the budget is assigned a state of 3 out of 3 to indicate that the magnitude of the budget information element has a high magnitude relative to the other perturbated inputs.

Designations may include other states (e.g., numerical values if the information elements include numerical data) and may be assigned via other methods without departing from embodiments disclosed herein.

The causal inferencing algorithm may include any methodology for establishing causation between variables and outputs using binary data (e.g., regression analysis, causal mediation analysis, propensity score matching, uplift modeling). The set of the causal relationships, therefore, may predict which portions of the input caused portions of the output to be generated by the generative AI model.

Thus, embodiments disclosed herein may improve processes of explaining outputs generated by generative AI models to downstream consumers of the outputs. By using the set of the causal relationships to provide the computer-implemented services, transparency of decision-making by the generative AI model to the downstream consumers may be increased.

To provide the above noted functionality, the system of FIG. 1 may include data processing systems 100, AI model manager 102, downstream consumers 106, and communication system 104. Each of these components is discussed below.

Data processing systems 100 may provide all, or a portion of, the computer-implemented services. Data processing systems 100 may include any number of data processing systems (e.g., 100A-100N) that may provide output generation services to downstream consumers 106. For example, a downstream consumer (e.g., 106A) may subscribe to output generation services provided by data processing system 100A and downstream consumer 106A may provide prompts (e.g., from clients, from owners of downstream consumer 106A, from employees of a company that owns downstream consumer 106A) to data processing system 100A as part of the subscribed services.

To provide computer-implemented services, data processing systems 100 may: (i) obtain inputs for generative AI models (e.g., hosted and/or operated by data processing systems 100), (ii) obtain, using the inputs and the generative AI models, outputs from the generative AI models, (iii) perform, using at least the inputs, the outputs, and the generative AI model, causality analysis processes to obtain sets of causal relationships between first information elements of the inputs and second information elements of the outputs, (iv) provide computer-implemented services to a downstream consumer using at least the set of the causal relationships, and/or (v) perform other actions. Refer to FIGS. 2B-2C for additional details regarding performing the causality analysis process. Refer to FIGS. 2D-2F for an example of graphical representations of perturbated inputs and an example of a binarized representation of a perturbated input.

Data processing systems 100 may populate a graphical user interface (GUI) using any data (e.g., graphical representations of data, graph data structures, binarized representations, outputs). The GUI may be accessible by other entities (e.g., downstream consumers 106) to view the data and/or interact with the data (e.g., to provide feedback).

AI model manager 102 may manage any number of AI models. For example, AI model manager 102 may: (i) obtain training data for AI models, (ii) train any number of AI models to obtain trained AI models, (iii) deploy trained AI models to other entities (e.g., data processing systems 100), (iv) update and/or modify trained AI models (e.g., fine-tune trained AI models based on additional training and/or production data), and/or (v) provide other AI model management services.

For example, AI model manager 102 may cooperatively provide at least a portion of the computer-implemented services to data processing systems 100 by: (i) obtaining training data from downstream consumers 106, (ii) training one or more AI models (e.g., generative AI models) using at least the training data obtained from downstream consumers 106 to obtain one or more trained AI models, (iii) deploying the one or more trained AI models to data processing systems 100 for use in providing output generation services for downstream consumers 106, and/or (iv) performing other actions.

Downstream consumers 106 may provide and/or consume all, or a portion of, the computer-implemented services. Downstream consumers 106 may include any number of downstream consumers (e.g., 106A-106N) and may include, for example, businesses, individuals, and/or devices (e.g., data processing systems) that may obtain outputs and/or other information based on the outputs (e.g., explainability information) as part of receiving the computer-implemented services.

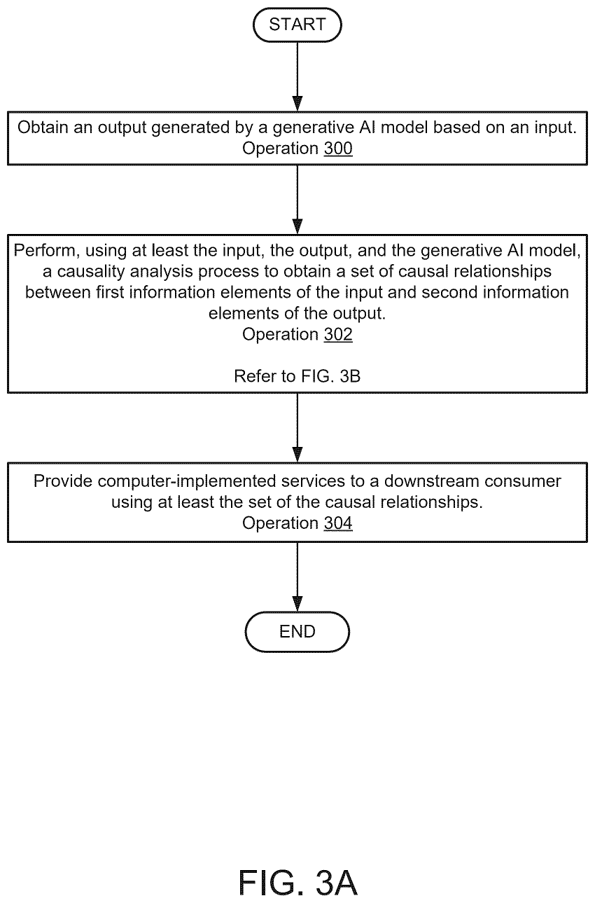

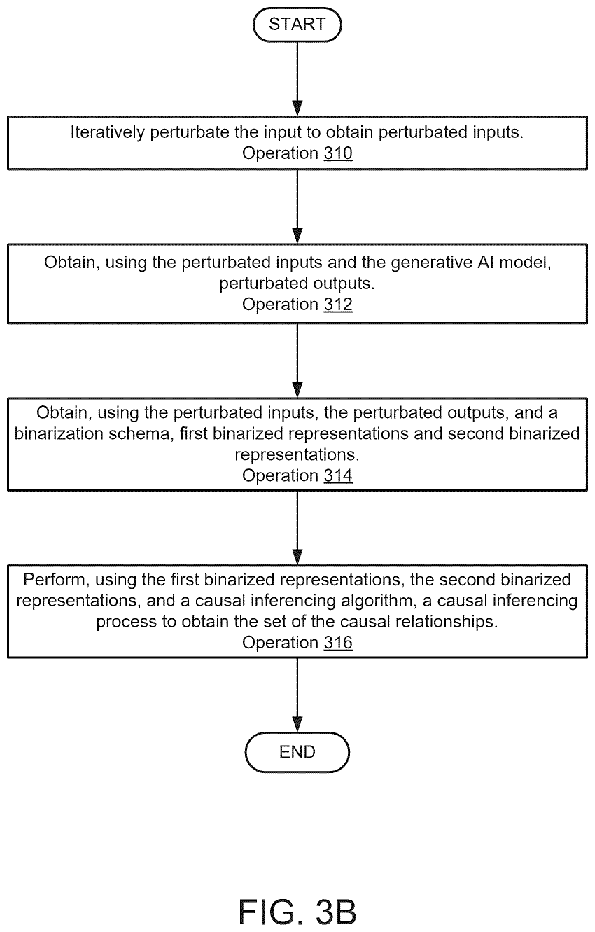

When providing their functionality, any of (and/or components thereof) data processing systems 100, AI model manager 102, and/or downstream consumers 106 may perform all, or a portion, of the actions and methods illustrated in FIGS. 2A-3B.

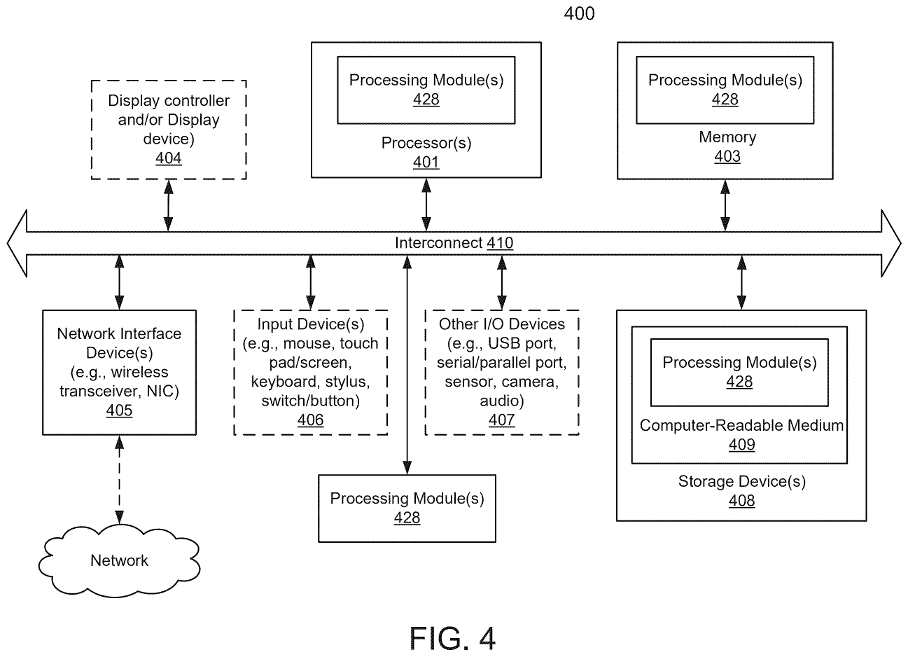

Any of (and/or components thereof) data processing systems 100, AI model manager 102, and downstream consumers 106 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to the discussion of FIG. 4.

Any of the components illustrated in FIG. 1 may be operably connected to each other (and/or components not illustrated) with communication system 104. In an embodiment, communication system 104 includes one or more networks that facilitate communication between any number of components. The networks may include wired networks and/or wireless networks (e.g., and/or the Internet). The networks may operate in accordance with any number and types of communication protocols (e.g., such as the internet protocol).

Communication system 104 may allow any of data processing systems 100, AI model manager 102, and downstream consumers 106 to communicate with one another (and/or with other devices not illustrated in FIG. 1). To provide its functionality, communication system 104 may be implemented with one or more wired and/or wireless networks. Any of these networks may be a radio access network (e.g., a cellular core network), a private network (e.g., the “Network” shown in FIG. 4), a public network, and/or may include the Internet. For example, data processing systems 100 may be operably connected to AI model manager 102 and downstream consumers 106 via the Internet. Data processing systems 100, AI model manager 102, downstream consumers 106, and/or communication system 104 may be adapted to perform one or more protocols for communicating via communication system 104.

While illustrated in FIG. 1 as including a limited number of specific components, a system in accordance with an embodiment may include fewer, additional, and/or different components than those illustrated therein.

While providing their functionality, any of data processing systems 100, AI model manager 102, and/or downstream consumers 106 may provide all or a portion of the methods shown in FIGS. 2A-3B.

To further clarify embodiments disclosed herein, data flow diagrams in accordance with an embodiment are shown in FIGS. 2A-2C. In these diagrams, flows of data and processing of data are illustrated using different sets of shapes. A first set of shapes (e.g., 200, 203, etc.) is used to represent data structures, a second set of shapes (e.g., 201, 204 etc.) is used to represent processes performed using and/or that generate data, a third set of shapes (e.g., 202) is used to represent generative AI models, algorithms, functions, schemas, and/or other types of models, a fourth set of shapes (e.g., 106A) is used to represent downstream consumers, and a fifth set of shapes (e.g., 208) is used to represent graphical user interfaces (GUIs).

Turning to FIG. 2A, a first data flow diagram in accordance with an embodiment is shown. The first data flow diagram may illustrate data used in and data processing performed in obtaining a set of causal relationships usable to provide computer-implemented services to downstream consumers.

To obtain the set of the causal relationships (e.g., set of causal relationships 206), output generation process 201 and causality analysis process 204 may be performed.

During output generation process 201, input 200 and generative AI model 202 may be used to generate output 203. Input 200 may include any data ingested by generative AI model 202 to generate output 203. For example, a prompt may be obtained for generative AI model 202 (e.g., from downstream consumer 106A). A prompt template and/or a pre-prompt may be used to modify formatting and/or information content of the prompt prior to feeding the prompt into an input layer of generative AI model 202. In addition, a retrieval-augmented generation (RAG) process may be performed to obtain and append supplemental information to the prompt prior to feeding the input into generative AI model 202. Therefore, input 200 may include: (i) a prompt (e.g., a re-formatted version of the prompt), (ii) a pre-prompt, (iii) a prompt template, (iv) RAG data, and/or (v) other data.

For example, generative AI model 202 may be an LLM (e.g., a neural network inference model) trained to generate language, understand language, and/or otherwise process requests related to languages. Generative AI model 202 may have been previously trained using training data and any training process (e.g., a global optimization process using gradient descent), the training data indicating goals for outputs generated by generative AI model 202 (e.g., outputs). Parameters of generative AI model 202 may be selected using an optimization process (e.g., an objective function may be defined in terms of the training data and outputs generated by generative AI model 202, and a global optimization method such as gradient descent may be used to identify parameters that most faithfully reproduce the trends in the training data). Once the parameters of generative AI model 202 are set, then generative AI model 202 may be used to generate outputs (e.g., responses) based on inputs. Generative AI model 202 may be trained using other methods without departing from embodiments disclosed herein.

Input 200 may be intended to elicit an output from a generative AI model that includes information content desired by downstream consumer 106A (e.g., at least a portion of input 200 may be obtained from downstream consumer 106A). A prompt of input 200, for example, may include human-interpretable text and may include a question. For example, the prompt may include: (i) a request from a user for help assessing a malfunction of a computer system, (ii) a request from a customer for a product recommendation, (iii) a request from an employee of a business for a recommendation regarding a financial product (e.g., whether to extend a line of credit to a customer), and/or (iv) other requests. Refer to FIG. 2D for an example of a prompt of input 200.

To generate output 203, input 200 may be provided to generative AI model 202 (e.g., input 200 may be fed into an input layer of generative AI model 202 as ingest). Output 203 may be responsive to input 200. For example, output 203 may include human-interpretable text that indicates: (i) instructions for troubleshooting a malfunction of a computer system, (ii) a product recommendation, (iii) a financial product recommendation, and/or (iv) other information.

Output 203, input 200, and generative AI model 202 may be used to perform causality analysis process 204. During causality analysis process 204, input 200 may be iteratively perturbated to obtain perturbated inputs. The perturbated inputs and generative AI model 202 may be used to generate perturbated outputs. The perturbated inputs, the perturbated outputs, and a binarization schema may be used to obtain first binarized representations of the perturbated inputs and second binarized representations of the perturbated outputs. The first binarized representations, the second binarized representations, and a causal inferencing algorithm may be used to perform a causal inferencing process to obtain set of causal relationships 206. Refer to FIGS. 2B-2C for additional details regarding performing causality analysis process 204.

Set of causal relationships 206 may include any number of causal relationships between information elements of input 200 and information elements of output 203. For example, a first causal relationship may indicate that inclusion of a first information element in input 200 may have caused generation of a second information element in output 203. Set of causal relationships 206 may be used to provide computer-implemented services to at least downstream consumer 106A.

For example, the dashed line between set of causal relationships 206 and GUI 208 indicates that set of causal relationships 206 may be uploaded to GUI 208 as part of providing the computer-implemented services. Downstream consumer 106A may have access to GUI 208 and, therefore, at least set of causal relationships 206 may be displayed to downstream consumer 106A via GUI 208. Downstream consumer 106A may subsequently use set of causal relationships 206 to make decisions.

Turning to FIG. 2B, a second data flow diagram in accordance with an embodiment is shown. The second data flow diagram may illustrate data used in and data processing performed during obtaining first binarized representations of perturbated inputs based on input 200 (e.g., described in FIG. 2A) and second binarized representations of perturbated outputs based on the perturbated inputs. FIG. 2B may include at least a partial expansion of causality analysis process 204 in FIG. 2A.

During causality analysis process 204, at least iterative perturbation process 210, output generation process 214, and binarization process 218 may be performed. During iterative perturbation process 210, information elements of input 200 may be obtained and iteratively modified. For example, iteratively modifying input 200 may include modifying a first information element of input 200 (e.g., removing the first information element, replacing the first information element with a replacement information element) to obtain a first perturbated input of perturbated inputs 212. The first information element may be selected: (i) randomly, (ii) based on a policy, (iii) using an information element replacement schema, (iv) based on user feedback (e.g., a client may select the information element via a GUI), and/or (v) via other methods.

The first information elements of input 200 may include any item, object, or entity in input 200 and the information elements may be identified via any algorithm, machine learning model, and/or rule set for natural language processing to extract information from text. Information elements may be extracted from other types of data modalities (e.g., images, audio, video) via object recognition algorithms or models. Information elements may be obtained via other methods without departing from embodiments disclosed herein.

For example, a prompt of input 200 may include the following text: “My computer is not working. It keeps re-starting and overheating. I have computer A and I use operating system B, monitor C, keyboard D, and mouse E. How do I fix it?” The first information elements extracted from input 200 may, therefore, include: (i) computer A, (ii) operating system B, (iii) monitor C, (iv) keyboard D, (v) mouse E, (vi) re-starting, (vii) overheating, and (viii) not working.

The first information elements may be stored as a list, as a graphical representation of the first information elements, as human-interpretable text that summarizes the first information elements, and/or in other formats. Refer to FIG. 2D for an example graphical representation of a prompt. The first information elements (e.g., the human-interpretable text, the graphical representation, the list) may be published to a client portal and may be accessible by a downstream consumer via a graphical user interface (GUI).

Continuing with the above example, information elements of input 200 may be iteratively removed (e.g., one information element may be removed at a time) to generate any number of perturbated inputs 212.

Input 200 may also be modified, for example, by replacing the first information element with a replacement information element (e.g., provided by a user via a GUI, obtained using a retrieval augmented generation (RAG) process and any number of data sources) to obtain a first perturbated input.

Perturbated inputs 212 and generative AI model 202 may be used to perform output generation process 214. During output generation process 214, perturbated inputs 212 may be provided as ingest to generative AI model 202 (e.g., one at a time) and perturbated outputs 216 may be obtained from generative AI model 202 (e.g., one perturbated output of perturbated outputs 216 may be obtained using each perturbated input of perturbated inputs 212 and generative AI model 202).

Perturbated inputs 212 may be used to generate first graphical representations of perturbated inputs 212 and perturbated outputs 216 may be used to generate second graphical representations of perturbated outputs 216 (not shown). Generating a first graphical representation of the first graphical representations may include: (i) obtaining graph data structures (nodes corresponding to information elements of a first perturbated input, edges representing relationships between the nodes), (ii) populating a graph with the graph data structures to generate the first graphical representation, and/or (iii) other methods. The graph data structures may, therefore, distill information content of the first perturbated input into structured data.

Perturbated inputs 212 (e.g., graph data structures extracted from perturbated inputs 212), perturbated outputs 216 (e.g., graph data structures extracted from perturbated outputs 216), and binarization schema 220 may be used to perform binarization process 218 to obtain first binarized representations 222 and second binarized representations 224. Binarization schema 220 may include instructions, constraints, algorithms, and/or other information usable to guide generation of first binarized representations 222 and second binarized representations 224.

During binarization process 218 and based on binarization schema 220, information elements of perturbated inputs 212 may be aggregated to obtain aggregated input information elements (not shown). In addition, information elements of perturbated outputs 216 may be aggregated to obtain aggregated output information elements (not shown).

For example, perturbated inputs 212 may include: (i) a first perturbated input and (ii) a second perturbated input. A first list of information elements (e.g., of the first perturbated input, obtained using graph data structures for the first perturbated input) and a second list of information elements (e.g., of the second perturbated input, obtained using graph data structures for the second perturbated input) may be obtained. The first list of the information elements and the second list of the information elements may be added to the aggregated input information elements. Obtaining the aggregated input information elements may include removing duplicate information elements (e.g., if an information element appears in the first perturbated input and the second perturbated input, the information element may only be added once to the aggregated input information elements).

The aggregated output information elements may be obtained using similar methods (e.g., based on graph data structures of perturbated outputs 216).

A first binarized representation of first binarized representations 222 (e.g., for a first perturbated input of perturbated inputs 212) may include a set of binary designations corresponding to the aggregated input information elements. For example, the first binarized representation may include: (i) a list of the aggregated input information elements, and (ii) a binary designation for each information elements of the list of the aggregated input information elements. The binary designation may indicate: (i) a presence of a first information element of the aggregated input information elements in the first perturbated input, or (ii) an absence of the first information element in the first perturbated input. Refer to FIG. 2F for an example of a binarized representation of a perturbated input.

First binarized representations 222, therefore, may include a binarized representation (e.g., including binary data) for each perturbated input of perturbated inputs 212 and second binarized representations 224 may include a binarized representation for each perturbated output of perturbated outputs 216.

Turning to FIG. 2C, a third data flow diagram in accordance with an embodiment is shown. The third data flow diagram may illustrate data used in and data processing performed during obtaining a set of causal relationships based on input 200 and output 203 (e.g., described in FIG. 2A). FIG. 2C may include at least a partial expansion of causality analysis process 204 in FIG. 2A and may be a continuation of the processes shown in FIG. 2B.

During causality analysis process 204, at least causal inferencing process 228 may be performed. During causal inferencing process 228, first binarized representations 222, second binarized representations 224, and causal inferencing algorithm 226 may be used to obtain set of causal relationships 229. Causal inferencing algorithm 226 may include any methodology, function, rule set, and/or other means for establishing causality between portions of binary data. Causal inferencing algorithm 226 may, therefore, include an algorithm for performing: (i) regression analysis, (ii) causal mediation analysis, (iii) propensity score matching, (iv) uplift modeling, and/or (v) any other causal inferencing method based on binary data to generate relationships between input variables and outputs.

Performing causality analysis process 204 may include executing causal inferencing algorithm 226 based on the binary data included in first binarized representations 222 and second binarized representations 224.

Set of causal relationships 229 may include any number of causal relationships between information elements of input 200 and information elements of output 203. Set of causal relationships 229 may, therefore, be usable to understand how modifying portions of input 200 may result in desired modifications to output 203. Set of causal relationships 229 may be provided to a downstream consumer as explainability information to increase usefulness of output 203 as part of providing computer-implemented services to the downstream consumer.

Thus, by implementing the data flow shown in FIG. 2A-2C, a system in accordance with embodiments disclosed herein may be used to obtain explainability information (e.g., sets of causal relationships) for the outputs generated by generative AI models based on inputs. Consequently, the explainability information may be used to understand why an output was generated by the generative AI model thereby increasing a reliability and/or usefulness of the output to the downstream consumer.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

Turning to FIG. 2D, an example of a prompt included in input 200 (e.g., described in FIG. 2A) and a graphical representation of the prompt (e.g., graphical representation 234) are shown. A customer (e.g., downstream consumer 106A described in FIG. 2A) may access graphical user interface (GUI) 230 through which the customer may provide a request for a product (e.g., a computer system) recommendation.

The customer may open a chat window as part of functionality of GUI 230 and may enter prompt 232 into the chat window. Prompt 232 may include the following text: “I need a server that can host a large language model (LLM) trained on 5 terabytes (TB) of data stored in ten databases. I also need a full backup for the databases. My budget is $200,000 for training and $250,000 for data backup.”

Graphical representation 234 may be displayed to a downstream consumer (e.g., the customer) via GUI 230. To obtain graphical representation 234, first information elements of prompt 232 may be extracted and stored as graph data structures. The graph data structures may be represented as nodes (e.g., 236, 238, 240, 242, 244, 246, 248, 250, and 252) with edges between the nodes (e.g., edge 237) to indicate relationships between the first information elements.

For example, the information elements extracted from prompt 232 may include: (i) “$200,000 budget” shown as node 236, (ii) “training” shown as node 240, (iii) “server” shown as node 238, (iv) “LLM” shown as node 242, (v) “data” shown as node 244, (vi) “databases” shown as node 246, (vii) “5 TB” shown as node 248, (viii) “backup” shown as node 250, and “$250,000 budget” shown as node 252.

The edges between the nodes (e.g., 237) may represent relationships (e.g., data dependencies, data flows, entities that cooperatively perform workloads). For example, edge 237 may connect node 236 and node 240 to indicate that the $200,000 budget is allocated for training.

Descriptive information may be embedded in the nodes as internal representations (not shown). For example, information regarding the databases (e.g., a type of the databases, a number of nodes of the databases) may be included in an internal representation of node 246. The internal representation may be shown, for example, if a user selects node 246 via GUI 230.

Turning to FIG. 2E, an example of a perturbated prompt based on prompt 232 (e.g., perturbated prompt 254) and a graphical representation of the perturbated prompt (e.g., graphical representation 256) are shown. Refer to iterative perturbation process 210 in FIG. 2B for details regarding obtaining perturbated prompt 254 based on prompt 232.

For example, to perturbate prompt 232, information content of node 236 may be replaced with information content of node 258. Perturbated prompt 254 may include the following text: “I need a server that can host a large language model (LLM) trained on 5 terabytes (TB) of data stored in ten databases. I also need a full backup for the databases. My budget is $275,000 for training and $250,000 for data backup.”

Graphical representation 256 may be displayed via GUI 230. Graphical representation 256 may include nodes 238, 240, 242, 244, 246, 248, 250, and 252 that were included in graphical representation 234, may not include node 236 (e.g., shown in FIG. 2D), and may include replacement node 258 (e.g., including the information element “$275,000 budget”). Edge 259 may connect node 258 and node 240 to indicate that the $275,000 budget is allocated for training.

Turning to FIG. 2F, an example of a binarized representation of a perturbated input is shown. For example, binarized representation 270 may correspond to perturbated prompt 254 shown in FIG. 2E and, therefore, graph data structures shown in graphical representation 256 in FIG. 2E. Binarized representation 270 may include two columns. For example, the left-hand column of binarized representation 270 may include a list of fifteen nodes. The fifteen nodes may be extracted from graph data structures associated with perturbated inputs 212 (e.g., described in FIG. 2B) to obtain aggregated input information elements.

The right-hand column of binarized representation 270 may include a binary designation (e.g., a 0 or a 1) corresponding to each of the fifteen nodes. As the graph data structures of graphical representation 256 include nodes 238, 240, 242, 244, 246, 248, 250, 252, and 258, binarized representation 270 may include a binary designation of “1” for each of the nodes present in perturbated prompt 254. As nodes 236, 260, 262, 264, 266, and 268 are not included in graphical representation 256, binarized representation 270 may include a binary designation of “0 ” for each of the nodes absent from perturbated prompt 254. Nodes 260, 262, 264, 266, and 268 are neither shown in graphical representation 234 nor graphical representation 256 (e.g., may be extracted from other perturbated inputs of perturbated inputs 212). Consequently, binarized representation 270 may include binary data indicating a presence or an absence of each of the aggregated input information elements in perturbated prompt 254. The binary designations may include other types of binary designations (e.g., “yes” or “no,” “A or B”) without departing from embodiments disclosed herein.

As discussed above, the components of FIG. 1 may perform various methods to manage a data processing system. FIGS. 3A-3B illustrate methods that may be performed by the components of the system of FIG. 1. In the diagrams discussed below and shown in FIGS. 3A-3B, any of the operations may be repeated, performed in different orders, and/or performed in parallel with or in a partially overlapping in time manner with other operations.

Turning to FIG. 3A, a first flow diagram illustrating a method of providing computer-implemented services using generative AI models in accordance with an embodiment is shown. The method may be performed, for example, by any of the components of the system of FIG. 1, and/or other components not shown therein.

At operation 300, an output generated by a generative artificial intelligence (AI) model based on an input may be obtained. Obtaining the output may include: (i) feeding the input into the generative AI model as ingest and obtaining the output from the generative AI model, (ii) providing the input to another entity responsible for operating the generative AI model and receiving the output from the entity in response, and/or (iii) other methods. The input may be obtained, least in part, from a downstream consumer, a subject matter expert (SME), and/or another entity. For example, a prompt may be obtained from the downstream consumer, a pre-prompt and/or prompt template may be used to modify formatting of the prompt, and/or a RAG process may be performed to append supplementary contextual information to the prompt to obtain the input.

At operation 302, a causality analysis process may be performed using at least the input, the output, and the generative AI model, to obtain a set of causal relationships between first information element of the input and second information elements of the output. The set of the causal relationships may be based, at least in part, on: (i) first binarized representations of perturbated inputs based on the input, and (ii) second binarized representations of perturbated outputs based on the perturbated inputs.

Performing the causality analysis process may include: (i) iteratively perturbating the input to obtain the perturbated inputs, (ii) obtaining, using the perturbated inputs and the generative AI model, the perturbated outputs, (iii) obtaining, using the perturbated inputs, the perturbated outputs, and a binarization schema, the first binarized representations and the second binarized representations, (iv) performing, using the first binarized representations, the second binarized representations and a causal inferencing algorithm, a causal inferencing process to obtain the set of the causal relationships, and/or (v) other methods. Refer to FIG. 3B for additional details regarding performing the causality analysis process.

At operation 304, computer-implemented services may be provided to a downstream consumer using at least the set of the causal relationships. Providing the computer-implemented services to the downstream consumer may include: (i) populating a GUI with at least the set of the causal relationships to obtain a populated GUI, (ii) feeding at least the set of the causal relationships into a second generative AI model to generate explainability information (e.g., in human-interpretable text), (iii) populating the GUI with the explainability information, (iv) making decisions based on at least the set of the causal relationships, (v) providing the set of the causal relationships, the explainability information, and/or other information to another entity (e.g., the downstream consumer), and/or (vi) other methods.

Populating the GUI with at least the set of the causal relationships may include: (i) uploading, via an application programming interface (API), the set of the causal relationships to the GUI, (ii) providing the set of the causal relationships to another entity responsible for uploading the set of the causal relationships to the GUI, and/or (iii) other methods.

The method may end following operation 304.

Turning to FIG. 3B, a second flow diagram illustrating a method of providing computer-implemented services using generative AI models in accordance with an embodiment is shown. The method may be performed, for example, by any of the components of the system of FIG. 1, and/or other components not shown therein. The method shown in FIG. 3B may be an expansion of operation 302 shown in FIG. 3A.

At operation 310, the input may be iteratively perturbated to obtain perturbated inputs. Iteratively perturbating the input may include obtaining first information elements of the input. Iteratively perturbating the input may also include at least one action selected from a list of actions consisting of: (i) removing a first information element of the first information elements to obtain a first perturbated input of the perturbated inputs, and (ii) replacing the first information element with a replacement information element to obtain the first perturbated input.

Obtaining the first information elements may include: (i) utilizing an algorithm, model, and/or rule set to perform natural language processing and/or object recognition to extract the first information elements from the input, (ii) providing the input to another entity responsible for extracting the first information elements, and/or (iii) other methods.

Removing the first information element of the first information elements to obtain the first perturbated input may include: (i) selecting the first information element (e.g., randomly, based on a schema, based on feedback from a downstream consumer), (ii) deleting the first information element from the first information elements, (iii) using a model (e.g., a second generative AI model) to create the first perturbated input based on the remaining information elements, and/or (iv) other methods.

Replacing the first information element with the replacement information element to obtain the first perturbated input may include: (i) deleting the first information element from the input, (ii) adding the replacement information element to the input to replace the first information element (e.g., a first budget may be replaced with a second budget), (iii) providing the input and the replacement information element to another entity responsible for replacing the first information element, and/or (iv) other methods.

If the at least one action performed as part of iteratively perturbating the input includes replacing the first information element, a replacement information element may be obtained prior to replacing the first information element. The replacement information element may be obtained based on the first information element and an information element replacement schema.

Obtaining the replacement information element may include: (i) obtaining the information element replacement schema (e.g., from storage, from another entity via a communication system, from a downstream consumer via a GUI), (ii) reading instructions from the information element replacement schema (e.g., for selecting the first information element, for obtaining the replacement information element), (iii) selecting, based on the information element replacement schema, the first information element (e.g., randomly, based on a hierarchy for preferential selection of different types of information elements), (iv) performing a search process (e.g., a lookup process, a RAG process) using the first information element to obtain one or more replacement information elements (e.g., from a database, from another entity, from any number of other data sources), and/or (v) other methods.

Iteratively perturbating the input may also include, if the at least one action includes replacing the first information element: (i) displaying, via a GUI, at least the first information elements to a user (e.g., a client, a downstream consumer), (ii) obtaining, via an interaction with the GUI, feedback from the user that includes the replacement information element, and/or (iii) other methods.

Displaying at least the first information elements to the user may include: (i) obtaining graph data structures (e.g., nodes, edges) based on the first information elements and relationships between the first information elements, (ii) generating, using the graph data structures, a first graphical representation of the first information elements, (iii) populating the GUI with the first graphical representation, and/or (iv) other methods.

The first graphical representation may display: (i) a first set of nodes that correspond to the first information elements, and (ii) first edges that indicate relationships between the first set of the nodes.

Obtaining the first graphical representation may include: (i) executing a graph generation algorithm based on the graph data structures and/or feeding the first information elements into an inference model to obtain the first set of nodes and internal representations (e.g., descriptors) for the first set of nodes, (ii) performing an analysis process, using the first set of the information elements and supplementary information, to obtain the first edges (e.g., indicating patterns of data flows, data dependencies, workload performance for various entities), and/or (iii) other methods.

Populating the GUI with the first graphical representation may include: (i) uploading the first graphical representation (e.g., via an application programming interface) so that the first graphical representation is available to the user via the GUI, (ii) providing the first graphical representation to another entity responsible for uploading the first graphical representation to the GUI, and/or (iii) other methods.

At operation 312, perturbated outputs may be obtained using the perturbated inputs and the generative AI model. Obtaining the perturbated outputs may include methods similar to those described with respect to operation 300 in FIG. 3A.

Prior to operation 314, first graphical representations of the perturbated inputs and second graphical representations of the perturbated outputs may be generated. Generating the first graphical representations and the second graphical representations may include methods similar to those described with respect to obtaining the first graphical representation in operation 310.

At operation 314, first binarized representations and second binarized representations may be obtained using the perturbated inputs, the perturbated outputs, and a binarization schema. Obtaining the first binarized representations and the second binarized representations may be based on the binarization schema and may include: (i) aggregating, using the perturbated inputs, information elements of the perturbated inputs to obtain aggregated input information elements, (ii) aggregating, using the perturbated outputs, information elements of the perturbated outputs to obtain aggregated output information elements, and/or other methods.

Obtaining a first binarized representation for a first perturbated input of the perturbated inputs, for example, may include comparing information elements of the first perturbated input to the aggregated input information elements to obtain a first binarized representation of the first binarized representations, the first binarized representation comprising a set of binary designations corresponding to the aggregated input information elements and/or other methods. Refer to FIG. 2F for an example of a binarized representation of a perturbated input.

Aggregating the information elements of the perturbated inputs may include: (i) obtaining first information elements of a first perturbated input of the perturbated inputs (e.g., via natural language processing, object recognition, via graph data structures including nodes and edges, and/or other methods), (ii) adding the first information elements to a data structure associated with the aggregated input information elements, (iii) obtaining second information elements of a second perturbated input of the perturbated inputs, (iv) adding the second information elements to the data structure associated with the aggregated input information elements, (v) repeating the above steps (e.g., obtaining information elements, adding the information elements to the data structure) for each remaining perturbated input of the perturbated inputs, and/or (vi) other methods.

Aggregating the information elements of the perturbated inputs may also include: (i) feeding the perturbated inputs into an inference model and/or other algorithm generate the aggregated input information elements (e.g., add information elements, delete duplicate information elements), (ii) providing the perturbated inputs to another entity responsible for generating the aggregated input information elements, and/or (iii) other methods.

Aggregating the information elements of the perturbated outputs to obtain the aggregated output information elements may include methods similar to those described with respect to aggregating the information elements of the perturbated inputs (e.g., using the perturbated outputs in place of the perturbated inputs).

Comparing the information elements of the first perturbated input to the aggregated input information elements to obtain the first binarized representation may include: (i) determining (e.g., manually by a subject matter expert, via a software program) whether each information element of the aggregated input information elements is present in the information elements of the first perturbated input, (ii) feeding the information elements of the first perturbated input and the aggregated input information elements into a model or algorithm, (iii) providing the information elements of the first perturbated input and the aggregated input information elements to another entity, and/or (iv) other methods.

Methods described with respect to obtaining the first binarized representation of the first binarized representations may be repeated for each remaining perturbated input of the perturbated inputs to obtain the first binarized representations.

Obtaining a first binarized representation of the second binarized representations (e.g., corresponding to a first perturbated output of the perturbated outputs), for example, may include comparing information elements of the first perturbated output to the aggregated output information elements to obtain the first binarized representation of the second binarized representations, the first binarized representation of the second binarized representations comprising a set of binary designations corresponding to the aggregated output information elements and/or other methods.

Methods described with respect to obtaining the first binarized representation of the second binarized representations may be repeated for each other perturbated output of the perturbated outputs to obtain the second binarized representations.

At operation 316, a causal inferencing process may be performed using the first binarized representations, the second binarized representations, and a causal inferencing algorithm, to obtain the set of the causal relationships. Performing the causal inferencing process may include: (i) executing the causal inferencing algorithm using binary data extracted from the first binarized representations and the second binarized representations to generate the set of the causal relationships, (ii) providing the first binarized representations, the second binarized representations, and the causal inferencing algorithm to another entity responsible for executing the causal inferencing algorithm to generate the set of the causal relationships, and/or (iii) other methods.

The method may end following operation 316.

Thus, as illustrated above, embodiments disclosed herein may provide systems and methods usable to provide computer-implemented services using generative AI models. By providing the computer-implemented services using the set of the causal relationships, a likelihood of the output meeting needs of the downstream consumer may be increased.

Any of the components illustrated in FIGS. 1-2F may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components, as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for providing computer-implemented services using generative artificial intelligence (AI) models, the method comprising:
obtaining an output generated by a generative AI model of the generative AI models based on an input;
performing, using at least the input, the output, and the generative AI model, a causality analysis process to obtain a set of causal relationships between first information elements of the input and second information elements of the output, the set of the causal relationships being based, at least in part, on:
first binarized representations of perturbated inputs based on the input, and
second binarized representations of perturbated outputs based on the perturbated inputs; and
providing computer-implemented services to a downstream consumer using at least the set of the causal relationships.

2. The method of claim 1, wherein the input comprises at least one type of input selected from a list of types of input consisting of:
a prompt for the generative AI model, and
a pre-prompt for the generative AI model.

3. The method of claim 1, wherein performing the causality analysis process comprises:
iteratively perturbating the input to obtain the perturbated inputs;
obtaining, using the perturbated inputs and the generative AI model, the perturbated outputs;
obtaining, using the perturbated inputs, the perturbated outputs, and a binarization schema, the first binarized representations and the second binarized representations; and
performing, using the first binarized representations, the second binarized representations and a causal inferencing algorithm, a causal inferencing process to obtain the set of the causal relationships.

4. The method of claim 3, wherein iteratively perturbating the input comprises:
obtaining the first information elements of the input; and
performing at least one action selected from a list of actions consisting of:
removing a first information element of the first information elements to obtain a first perturbated input of the perturbated inputs; and
replacing the first information element with a replacement information element to obtain the first perturbated input.

5. The method of claim 3, further comprising:
prior to obtaining the first binarized representations and the second binarized representations:
generating first graphical representations of the perturbated inputs; and
generating second graphical representations of the perturbated outputs.

6. The method of claim 5, wherein a first graphical representation of the first graphical representations comprises:
nodes corresponding to information elements of a first perturbated input of the perturbated inputs; and
edges indicating relationships between the nodes.

7. The method of claim 3, wherein obtaining the first binarized representations and the second binarized representations comprises:
based on the binarization schema:
aggregating, using the perturbated inputs, information elements of the perturbated inputs to obtain aggregated input information elements;
aggregating, using the perturbated outputs, information elements of the perturbated outputs to obtain aggregated output information elements; and
for a first perturbated input of the perturbated inputs:
comparing information elements of the first perturbated input to the aggregated input information elements to obtain a first binarized representation of the first binarized representations, the first binarized representation comprising a set of binary designations corresponding to the aggregated input information elements.

8. The method of claim 7, wherein the set of the binary designations comprises a first binary designation that indicates:
a presence of a first information element of the aggregated input information elements in the first perturbated input, or
an absence of the first information element of the aggregated input information elements in the first perturbated input.

9. The method of claim 3, wherein the causal inferencing algorithm comprises at least one causal inferencing algorithm selected from a list of causal inferencing algorithms consisting of:
regression analysis,
causal mediation analysis,
propensity score matching, and
uplift modeling.

10. The method of claim 1, wherein providing the computer-implemented services to the downstream consumer comprises:
populating a graphical user interface (GUI) with at least the set of the causal relationships to obtain a populated GUI, the populated GUI being accessible by the downstream consumer.

11. The method of claim 1, wherein the generative AI model is a large language model (LLM).

12. A non-transitory machine-readable medium having instructions stored therein, which when executed by a processor, cause the processor to perform operations for providing computer-implemented services using generative artificial intelligence (AI) models, the operations comprising:
obtaining an output generated by a generative AI model of the generative AI models based on an input;
performing, using at least the input, the output, and the generative AI model, a causality analysis process to obtain a set of causal relationships between first information elements of the input and second information elements of the output, the set of the causal relationships being based, at least in part, on:
first binarized representations of perturbated inputs based on the input, and
second binarized representations of perturbated outputs based on the perturbated inputs; and
providing computer-implemented services to a downstream consumer using at least the set of the causal relationships.

13. The non-transitory machine-readable medium of claim 12, wherein the input comprises at least one type of input selected from a list of types of input consisting of:
a prompt for the generative AI model, and
a pre-prompt for the generative AI model.

14. The non-transitory machine-readable medium of claim 12, wherein performing the causality analysis process comprises:
iteratively perturbating the input to obtain the perturbated inputs;
obtaining, using the perturbated inputs and the generative AI model, the perturbated outputs;
obtaining, using the perturbated inputs, the perturbated outputs, and a binarization schema, the first binarized representations and the second binarized representations; and
performing, using the first binarized representations, the second binarized representations and a causal inferencing algorithm, a causal inferencing process to obtain the set of the causal relationships.

15. The non-transitory machine-readable medium of claim 14, wherein iteratively perturbating the input comprises:
obtaining the first information elements of the input; and
performing at least one action selected from a list of actions consisting of:
removing a first information element of the first information elements to obtain a first perturbated input of the perturbated inputs; and
replacing the first information element with a replacement information element to obtain the first perturbated input.

16. The non-transitory machine-readable medium of claim 14, wherein the operations further comprise:
prior to obtaining the first binarized representations and the second binarized representations:
generating first graphical representations of the perturbated inputs; and
generating second graphical representations of the perturbated outputs.

17. A data processing system, comprising:
a processor; and
a memory coupled to the processor to store instructions, which when executed by the processor, cause the processor to perform operations for providing computer-implemented services using generative artificial intelligence (AI) models, the operations comprising:
obtaining an output generated by a generative AI model of the generative AI models based on an input;
performing, using at least the input, the output, and the generative AI model, a causality analysis process to obtain a set of causal relationships between first information elements of the input and second information elements of the output, the set of the causal relationships being based, at least in part, on:
first binarized representations of perturbated inputs based on the input, and
second binarized representations of perturbated outputs based on the perturbated inputs; and
providing computer-implemented services to a downstream consumer using at least the set of the causal relationships.

18. The data processing system of claim 17, wherein the input comprises at least one type of input selected from a list of types of input consisting of:
a prompt for the generative AI model, and
a pre-prompt for the generative AI model.

19. The data processing system of claim 17, wherein performing the causality analysis process comprises:
iteratively perturbating the input to obtain the perturbated inputs;
obtaining, using the perturbated inputs and the generative AI model, the perturbated outputs;
obtaining, using the perturbated inputs, the perturbated outputs, and a binarization schema, the first binarized representations and the second binarized representations; and
performing, using the first binarized representations, the second binarized representations and a causal inferencing algorithm, a causal inferencing process to obtain the set of the causal relationships.

20. The data processing system of claim 19, wherein iteratively perturbating the input comprises:
obtaining the first information elements of the input; and
performing at least one action selected from a list of actions consisting of:
removing a first information element of the first information elements to obtain a first perturbated input of the perturbated inputs; and
replacing the first information element with a replacement information element to obtain the first perturbated input.
